(19) United States
(12) Patent Application Publication
(10) Pub. No.: US 2025/0051185 A1
(43) Pub. Date: Feb. 13, 2025

(54) METHOD FOR REDUCING A CONTENT OF FORMALDEHYDE IN AN AQUEOUS MEDIUM

(71) Applicant: DÜRR SYSTEMS AG, Bietigheim-Bissingen (DE)

(72) Inventors: Christian EICHHORN, Sachsenheim (DE); Andreas KLEINMICHEL, Bietigheim-Bissingen (DE)

(21) Appl. No.: 18/719,641

(22) PCT Filed: Dec. 2, 2022
(86) PCT No.: PCT/DE2022/100904

§ 371 Date: Jun. 13, 2024

(30) Foreign Application Priority Data
Dec. 15, 2021 (DE) 10 2021 133 251.6

(51) Int. Cl. C02F 1/20; C02F 101/34

(52) U.S. Cl. CPC C02F 1/20; C02F 2101/34; C02F 2209/02; C02F 2209/06; C02F 2305/00

(57) ABSTRACT

A method is proposed with which a content of formaldehyde in aqueous media that are conducted in a circular flow, in particular within a circular flow of a gas scrubbing installation, can be reduced in an economical and sustainable manner, wherein the formaldehyde in the aqueous medium is chemically bound during a predetermined reaction time in a reaction zone in the course of a formosis reaction in such a way that a release of formaldehyde from the aqueous medium into a gas phase at a temperature of 95° C., an ambient pressure of 1 bar, during a test time interval of 10 min is limited to a concentration of formaldehyde in the gas phase of about 1 ppm or less, wherein the aqueous medium for chemically binding the formaldehyde in the course of the formosis reaction in the reaction zone for the predetermined reaction time is held at a reaction temperature of about 50° C. to about 100° C. and the pH value of the aqueous medium is set to an alkaline pH value in the range of about 11 to about 14.

### RELATED APPLICATIONS

This application is a national phase of international application No. PCT/DE2022/100904 filed on Dec. 2, 2022, and claims the benefit of German application No. 10 2021 133 251.6 filed on Dec. 15, 2021. The foregoing International Patent Application and the German Patent Application are incorporated herein by reference in their entireties.

### FIELD OF DISCLOSURE

The disclosure relates to a method for reducing a content of formaldehyde in an aqueous medium, as well as wet filter installations that are configured for performing the method in accordance with examples disclosed herein.

### BACKGROUND

Formaldehyde is released in a large number of industrial manufacturing processes, for example in the wood-processing industry, and is present in the gas atmosphere in concentrations that are not negligible. Due to the toxicity of the formaldehyde, it must be removed from the gas atmosphere, for which so-called wet filter installations, in particular so-called wet electrostatic precipitators (also abbreviated as WESP), are typically used, which absorb the formaldehyde from the gas phase in an aqueous medium. For economic reasons, the wet filter installations are operated with the lowest possible consumption of fresh water, which is why the content of the formaldehyde can increase in a few operating hours to values that can lead to desorption and thus a renewed release of the formaldehyde. This effect is observed despite the good solubility of formaldehyde in water and the spontaneous reaction to methanediol (methylene glycol) at increasing formaldehyde concentrations. The dissertation by Jozef G. M. Winkelmann (2003), “Absorption of Formaldehyde in Water”, University of Groningen NL, details the relationships in the system formaldehyde and water.

U.S. Pat. No. 4,104,162 A1 proposes to react formaldehyde-containing wastewater from industrial manufacturing processes with hydrogen peroxide in the presence of a base. According to the embodiments of U.S. Pat. No. 4,104,162 A1, base is always added slightly hyperstoichiometrically to the dissolved formaldehyde. In addition, this document requires the use of hydrogen peroxide to remove the formaldehyde quickly and quantitatively at an initial temperature of 10° C. to 35° C.

In addition, it is widely known from the scientific literature that formaldehyde can be converted in an aqueous medium into polyhydroxy compounds, in particular also sugars such as fructose and glucose. For example, reference can be made here to the German patent specification DE 27 21 186 C2, which describes the conversion of formaldehyde in the presence of a metal-based catalyst and an en-diol-capable co-catalyst to a mixture of low molecular weight, polyhydric alcohols.

The disadvantage of this method is that it is necessary to work close to the boiling point of the water. On the one hand, this is necessary in order to be able to remove the water from the later product mixture as energy-efficiently as possible in accordance with this document, and on the other hand, the high absorption performance at these temperatures is only achieved by the polyhydric alcohols, which react with formaldehyde under dehydration to the respective acetals. Thus, the distillation shifts the equilibrium to the side of acetal products. Since the declared objective of DE 27 21 186 C2 is the production of saleable low molecular weight polyhydroxyl compounds, a reduction in product quality due to color change, caused by a further reaction of the formosis reaction products to sugar acids, must be controlled and prevented by strict pH control in the neutral range. A significant slowing of the reaction speed due to a low pH value and the low concentration of metal hydroxide catalysts is accepted here.

The method according to DE 27 21 186 C2 works with high formaldehyde concentrations in the aqueous medium with relatively low catalyst concentrations.

### SUMMARY

The object of examples disclosed herein is to propose a method with which a content of formaldehyde in aqueous media, which are conducted in a circular flow, can be reduced in an economical and sustainable manner.

This object is achieved, in accordance with examples disclosed herein, by a method in accordance with Claim 1.

In the method in accordance with examples disclosed herein, the content of formaldehyde in an aqueous medium conducted in a circular flow, in particular within a circuit of a gas scrubbing installation, is reduced by formaldehyde in the aqueous medium being chemically bound during a predetermined reaction time in a reaction zone in the course of a formosis reaction. This may take place batch-wise or continuously, such that a release of formaldehyde from the aqueous medium at a temperature of 95° C. into a gas phase at an ambient pressure of 1 bar during a time test interval of 10 min is limited such that a concentration of formaldehyde in the gas phase of 1 ppm or less is achieved at the end of the test interval. Here the aqueous medium for chemically binding the formaldehyde in the course of a formosis reaction in the reaction zone for the predetermined reaction time is maintained at a reaction temperature of about 50° C. to about 100° C. and the pH value of the aqueous medium is set to an alkaline pH value in the range of about 11 to about 14. If necessary, for chemically binding the formaldehyde in the course of the formosis reaction, the aqueous medium is first heated from a first temperature to the reaction temperature.

The setting of the reaction temperature is preferably carried out in one or more reaction zones, which are operated thermally separated from the circulating aqueous medium without heating it. The catalysts and, optionally, co-catalysts dissolved or suspended in the aqueous medium can be added to the reaction zone(s) if required.

In accordance with examples disclosed herein, comparatively low formaldehyde concentrations in the aqueous medium and preferably comparatively high catalyst concentrations are worked with compared to the method according to the document DE 27 21 186 C2. This enables a chemical binding of the formaldehyde in accordance with examples disclosed herein, even at lower reaction temperatures.

Gas scrubbing installations within the meaning of examples disclosed herein are generally installations for treating gases, in particular air, which are charged with formaldehyde and possibly other pollutants, in such a way that the content of formaldehyde and possibly the other pollutants in the gases is reduced. Gas scrubbing systems in this sense are, in addition to a multitude of other types, in particular wet filter systems and wet electrostatic precipitators (WESP), whereby the latter can also be used to efficiently separate particulate components in the gases in parallel to the reduction of the formaldehyde content.

The formaldehyde content delivered to the gas phase in the test interval can be determined by means of photometric methods (VDI 3862 Sheet 6:2004-02 Gaseous Emission Measurement; Measurement of Formaldehyde by the Acetylacetone Method, Beuth Verlag, Berlin; Gas chromatography (ASTM D5197-16 Standard Test Method for Determination of Formaldehyde and Other Carbonyl Compounds in Air (Active Sampler Methodology)).

In the course of the chemical binding of the formaldehyde in accordance with examples disclosed herein beyond the formation of methanediol, compared with formaldehyde, the reaction product(s) has/have a significantly lower volatility in the aqueous medium, and thus the aqueous medium can initially be used in the circuit for the absorption of new proportions of formaldehyde without further processing/treatment. The reaction products are also active as co-catalysts and in turn accelerate the reaction of formaldehyde and methanediol and cannot react back to them. The significant amounts of fresh water supply that are otherwise necessary in the prior art can thus be significantly reduced according to examples disclosed herein.

When reference is made in the context of the description of examples disclosed herein to a formaldehyde content in an aqueous medium, the formaldehyde content comprises, in addition to the formaldehyde itself still present in small amounts, in particular also its hydrated form, namely methanediol, and reaction products of the chemical binding of the formaldehyde sought according to examples disclosed herein.

The reaction product(s) of the method in accordance with examples disclosed herein can be concentrated in the circular flow up to a predetermined value and can be conducted in the circular flow without problems.

If the content of the reaction products reaches or exceeds a predetermined value, in particular about 150 mg/l of the aqueous medium, it is usually sufficient to remove a comparatively small portion of the aqueous medium with substantially enriched reaction products from the circuit and to replace it with fresh water or a treated aqueous medium with low proportions of reaction products. Since the reaction products in the method in accordance with examples disclosed herein are predominantly in the form of low molecular weight carbohydrates, a regeneration can be carried out in an environmentally friendly process (e.g., fermentation and other biological degradation processes, as described in detail in the literature, e.g. in the BAT Reference Document for Common Waste Water and Waste Gas Treatment/Management Systems in the Chemical Sector; February 2003; German Federal Environmental Agency) or chemical-physical processes, such as adsorption on activated carbon. After regeneration, the aqueous medium can be returned to the circular flow as a treated aqueous medium.

A corresponding amount of catalyst must be redosed until the predetermined concentration is reached. It may also be necessary to set the pH value according to the predetermined value. For the reasons mentioned above, redosing of co-catalysts is usually not necessary or only to a very small extent.

Preferably, in the method in accordance with examples disclosed herein, the reaction temperature for the formosis reaction is about 85° C. to about 95° C., most preferably a reaction temperature is in the range of about 90° C. to 95° C. In the preferred ranges of the reaction temperature, the reaction speed is on the one hand sufficient to convert within a short time a noticeable proportion of the formaldehyde content into one or more reaction products, in particular carbohydrates, and on the other hand, the reaction for chemically binding of the formaldehyde can be controlled in such a way that high molecular weight reaction products that could lead to disturbances in the circuit are only produced to a small extent or are avoided entirely. In particular, the formation of high molecular weight, in particular multifunctional carboxylic acids, can be avoided to a greater extent, which would otherwise result in the use of increased amounts of bases and catalysts.

Preferably, in the method in accordance with examples disclosed herein, the pH value of the aqueous medium is set to a pH value in the range of about 11 to about 13. This limitation of reaction conditions also contributes to a controlled reaction course of the reaction for chemically binding formaldehyde.

In particular, in the method in accordance with examples disclosed herein, the alkaline pH value can be set by adding an alkaline compound to the aqueous medium, in particular selected from sodium hydroxide and calcium hydroxide, in particular in the form of lime milk, or mixtures thereof. The use of lime milk and/or its derivatives is a particularly preferred embodiment of examples disclosed herein, since the particles separated by the wet filter installation agglomerate particularly well due to the effect of the lime milk and a better settling (sedimentation) and thus a simpler purification or regeneration of the liquid medium (hereinafter also referred to as process water) is made possible.

Preferably, the chemical binding of the formaldehyde is carried out as a polycondensation reaction in the presence of a catalyst, wherein the catalyst preferably comprises a formosis reaction catalyst, which is selected, in particular, from calcium ion-based catalysts, in particular Ca(OH)₂ and the more soluble compounds CaCl₂ and calcium formate, wherein the predetermined pH value can be set optionally by an addition of NaOH.

The catalyst is present in the aqueous medium preferably in a concentration that is equal to or greater than the concentration of the chemically unbound formaldehyde. Within the meaning of examples disclosed herein, chemically unbound formaldehyde is understood to mean the formaldehyde itself and the methanediol and its salts present in an aqueous solution in equilibrium therewith. Within the meaning of examples disclosed herein, chemically bound formaldehyde is present in the form of reaction products of the formosis reaction and, as the case may be, of subsequent reactions.

In addition, it is preferred if, in the method in accordance with examples disclosed herein, the aqueous medium comprises a co-catalyst, in particular in the form of an en-diol-capable sugar, in particular in the form of fructose, corn syrup, and/or glycolaldehyde.

In the presence of such co-catalysts, the method in accordance with examples disclosed herein can also be performed effectively at comparatively low reaction temperatures of about 50° C.

The use of the type and quantity of the co-catalyst should be carefully considered. Although a very high initial concentration of co-catalysts ensures a very rapid reaction of the dissolved formaldehyde, the resulting highly reactive fructose is converted into glucose in the alkaline medium via a Lobry de Bruyn-Alberda van Ekenstein transformation, which in turn decomposes under the influence of the alkaline medium into products of the substance class of reductones, such as, e.g., 2-hydroxymalonaldehyde (CAS Number 497-15-4). All of these reactions, in turn, consume hydroxide ions and the conversion of formaldehyde is therefore reduced.

In the method in accordance with examples disclosed herein, the predetermined reaction time (corresponding to the average dwell time in the reaction zone or in a reactor vessel forming the reaction zone during continuous operation) is preferably limited to about 10 min or less, in particular about 2 min to about 5 min. This not only prevents the formation of too large amounts of high molecular weight reaction products or undesirable side reactions from occurring, as already mentioned, but the volume to be provided for the chemical binding of formaldehyde in a reaction zone can be limited to an economic size.

It is also advantageous for limiting the formation of high molecular weight polycondensation products in the course of the chemical binding of the formaldehyde if, in the method in accordance with examples disclosed herein, the aqueous medium after the predetermined reaction time when using higher reaction temperatures, in particular from about 70° C. to about 95° C., is cooled from the reaction temperature by about 25° C. or more, in particular by about 30° C. or more, to a second temperature. Here, cooling to a level of a first temperature that prevails in the circuit, which may be about 65° C., for example, can be sufficient. In this case, the second temperature corresponds to the first temperature.

Preferably, in the method in accordance with examples disclosed herein, the cooling of the aqueous medium from the reaction temperature to the second temperature is performed within about 2 min or less. This significantly reduces the proportion of undesirable side reactions to be expected, in particular the formation of high molecular weight, in particular multifunctional carboxylic acids.

The heating of the aqueous medium to the reaction temperature and the cooling after the predetermined reaction time can be performed in a particularly simple and energy-saving manner in a heat exchanger in which the aqueous medium before the formosis reaction and the aqueous medium after the formosis reaction are conducted in opposite directions.

Preferably, to achieve a substantially constant formaldehyde absorption by the aqueous medium conducted in the circuit at regular intervals, optionally substantially continuously, a predetermined volume of the aqueous medium with a high content of chemically bound formaldehyde is discharged from the circuit and, in particular, replaced by fresh, i.e. substantially formaldehyde and reaction product-free aqueous medium. A regenerated aqueous medium that was previously discharged from the circuit may also be used here. The discharge of the predetermined volume is carried out, in particular, when the content of chemically bound formaldehyde in the aqueous medium is about 150 mg/l or more.

The content of chemically bound formaldehyde in the aqueous medium can be measured, for example, by means of photometric methods (VDI 3862 Sheet 6:2004-02 Gaseous Emission Measurement; Measurement of Formaldehyde by the Acetylacetone Method, Beuth Verlag, Berlin; Gas chromatography (ASTM D5197-16 Standard Test Method for Determination of Formaldehyde and Other Carbonyl Compounds in Air (Active Sampler Methodology)) or by countertitration of the sodium ion released during sulfite addition.

A further aspect of examples disclosed herein relates to a gas scrubbing installation, in particular a wet filter installation, preferably a wet electrostatic precipitator installation, comprising a scrubbing apparatus for absorbing formaldehyde from a gas phase into an aqueous medium while forming an aqueous, formaldehyde-containing medium, wherein the gas scrubbing installation comprises a circuit for the aqueous medium, and wherein the gas scrubbing installation has at least one reaction zone in which the method in accordance with examples disclosed herein may be carried out, as previously described.

The gas scrubbing installations in accordance with examples disclosed herein may be equipped with one single reaction zone or two or more reaction zones.

In particular, the reaction zone(s) is/are provided in the form of a separate reactor vessel or separate reactor vessels. In addition, components of the circulation system of the gas scrubbing installation can also be used as reaction zones, in particular pipe portions of the circulation system, which are optionally adapted in their volume, or also a recirculation tank typically used in the circulation system.

The aqueous medium can be discharged from the circuit and transferred to the reaction zone(s) or the reactor vessels(s) in a continuous or also timed manner, optionally in dependence on the respective given absorption of formaldehyde in the aqueous medium per unit of time.

In the case of the gas scrubbing installation in accordance with examples disclosed herein, the circuit preferably has a heating apparatus for heating the aqueous medium to a predetermined reaction temperature before entry and/or upon entry into the reaction zone, for example the reactor vessel, and/or in the reaction zone/in the reactor vessel itself.

Further preferably, the gas scrubbing installation in accordance with examples disclosed herein has a cooling apparatus for cooling the aqueous medium from the reaction temperature to a second temperature below the reaction temperature, for example the first temperature, after exit from the reaction zone, for example the reactor vessel.

Preferably, the gas scrubbing installation in accordance with examples disclosed herein comprises a heat exchanger in which the aqueous medium before introduction into a reaction zone or a reactor vessel and the aqueous medium after removal from a reaction zone or a reactor vessel are conducted in opposite directions while exchanging heat.

Gas scrubbing installations of examples disclosed herein preferably have a dosing apparatus with which an agent for increasing the pH value of the aqueous medium, optionally a catalyst for the polycondensation reaction of the formaldehyde and optionally also a co-catalyst, can be introduced.

Examples disclosed herein are described in more detail with reference to the drawing and the following examples.

### BRIEF DESCRIPTION OF THE DRAWINGS

FIG. 1 shows a simplified schematic depiction of the basic components of a gas scrubbing installation in the form of a wet filter installation;

FIG. 2 shows a recirculation installation for the wet filter installation from FIG. 1, which serves to perform the method in accordance with examples disclosed herein;

FIG. 3 shows a variant of a portion of the recirculation installation from FIG. 2; and

FIG. 4 shows a further variant of a recirculation installation for the wet filter installation from FIG. 1.

### DETAILED DESCRIPTION

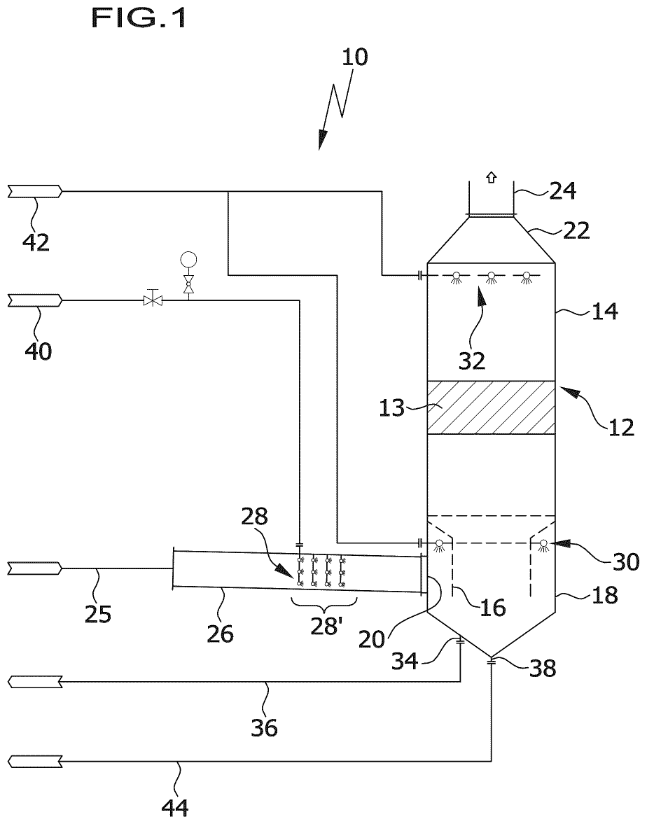

FIG. 1 shows in a schematically simplified depiction a gas scrubbing installation in the form of a wet filter installation 10, which can also be designed, in particular, as a so-called wet electrostatic precipitator (WESP) (not shown). The wet filter installation 10 comprises a filter apparatus 12 with a filter housing 14 in which a filter unit 13 (shown only schematically) is positioned. The gas scrubbing installation 10 serves, in particular, to purify exhaust gases from industrial manufacturing processes (raw gas), which often have temperatures of more than 100° C., for example 135° C.

In the lower region, the filter apparatus 12 (upstream side) has a raw gas chamber 18, which comprises a supply opening 20 for raw gas to be treated.

In the upper region, the filter apparatus 12 (downstream side) has a clean gas chamber 22, which is provided with an outlet channel 24 for the gas purified in the filter apparatus 12, hereinafter also called pure gas.

The raw gas to be purified in the wet filter installation 10 is introduced into the filter apparatus 12 or its raw gas chamber 18 through a raw gas channel 25, a scrubbing apparatus 26, and the supply opening 20.

Preferably, the scrubbing apparatus 26 comprises a spray scrubbing unit 28, as depicted, or a plurality, for example four, spray scrubbing units 28 (denoted as a whole as 28′) arranged one behind the other in the flow direction of the raw gas, which serve to cool the raw gas on the one hand and to scrub the formaldehyde contained in the raw gas with an aqueous medium on the other hand. Often, in this portion of the wet filter installation 10, already about 90% or more, in particular about 95% or more of the formaldehyde content originally contained in the raw gas can be scrubbed out and absorbed in the aqueous medium.

The raw gas pre-treated in this way enters the raw gas chamber 18 through the supply opening 20. The aqueous medium enriched with the scrubbed-out formaldehyde also enters the raw gas chamber 18 via the supply opening 20 and collects there in a bottom region of the chamber 18. The scrubbing apparatus 26 is preferably, as shown in FIG. 1, slightly inclined to the horizontal, such that the aqueous medium enriched with formaldehyde is able to easily flow from the scrubbing apparatus 26 into the raw gas chamber 18.

If required, the raw gas can be further treated with aqueous medium by way of an optionally provided spray apparatus 30 in the raw gas chamber 18. The spray apparatus 30 can also be used, in particular, for cleaning the raw gas chamber 18 itself from particulate contents of the raw gas that have entered there and sedimented.

The raw gas is diverted after entry into the raw gas chamber 18 by means of a redirection 16 in the direction toward the bottom of the raw gas chamber 18 and then flows substantially laminarly upwards through the filter apparatus 12 to the clean gas chamber 22.

The pre-treated raw gas hereby flows through the filter unit 13, while separating out particulate contents, and then enters the pure gas chamber 22. The pure gas chamber 22 can be equipped with electrodes for generating an electrostatic field to improve the separation of particulate contents of the raw gas in a known manner (not shown).

Also in the pure gas chamber 22, a spray apparatus 32 can be provided with which a further wet treatment of the pure gas and/or a backflushing of the filter unit can be carried out for cleaning off particles separated from the raw gas.

The raw gas chamber 18 is equipped in its lower region with an outlet 34 for the aqueous medium enriched with formaldehyde, said outlet being adjoined by a line 36. The raw gas chamber 18 further has an outlet 38 at the base, which serves to remove aqueous medium enriched with particulate contents via a discharge line 44.

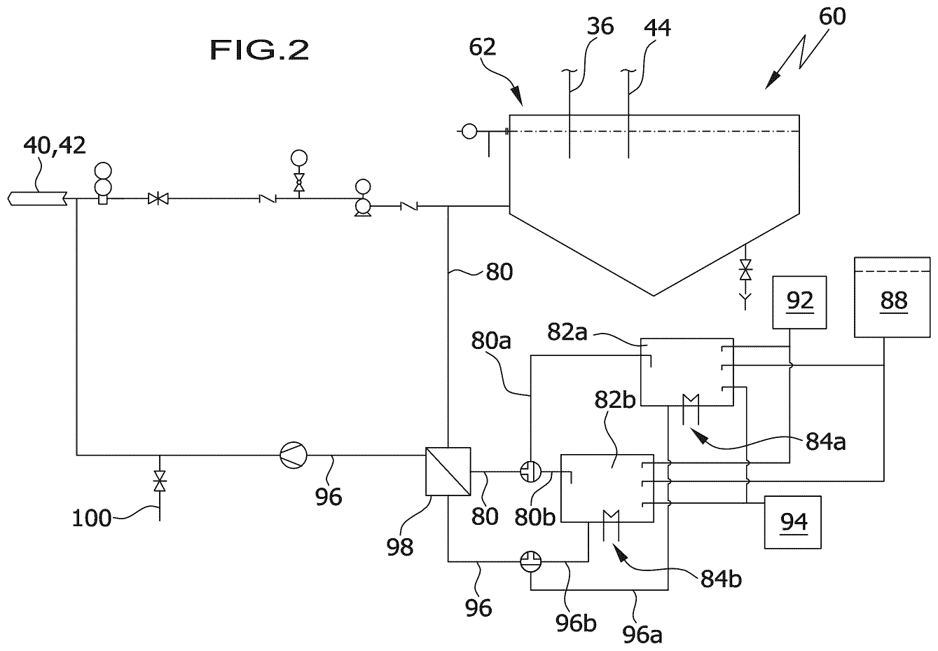

The aqueous medium discharged via the line 36 is, optionally after a treatment reducing the formaldehyde content in a recirculation installation 60, 60′, and 60″ schematically depicted in FIGS. 2 to 4, conducted in the circuit and supplied back to the spray scrubbing apparatus 26 via a supply line 40 and optionally to the spray apparatus(es) 30, 32 via a supply line 42.

FIG. 2 shows schematically a recirculation installation 60 for the wet filter installation 10 with a recirculation tank 62 in which the aqueous medium enriched with formaldehyde is fed by means of the line 36 and temporarily stored. For example, the temperature of the aqueous medium in the recirculation tank 62 is about 65° C.

The aqueous medium from the discharge line 44—after prior separation of the particulate contents, for example by way of a filter (not shown)—can optionally also be supplied to the recirculation tank 62.

In accordance with examples disclosed herein, as soon as the aqueous medium of the circuit has a predetermined content of formaldehyde and methanediol (chemically unbound formaldehyde) and chemically bound formaldehyde, optionally as formose reaction products (for example, 100 mg/l or more), a certain proportion of the circulated aqueous medium is no longer supplied directly to the various components (spray scrubbing apparatus 26, spray scrubbing apparatuses 30, 32) of the wet filter installation 10, but instead is diverted from the circuit via a line 80 and supplied to a first reaction zone (here to the first reactor vessel 82a) via a line 80a.

In the first reaction zone or the first reactor vessel 82a, the aqueous medium is heated, if necessary, with a heating apparatus 84a to a predetermined reaction temperature of about 70° C. or more, preferably in the range of about 85° C. to about 95° C., in particular about 90° C. to about 95° C. Base, catalyst, and optionally co-catalyst from a storage tank 88 containing base, a catalyst tank 92, and a tank 94 containing co-catalyst respectively are added to the aqueous medium in the first reactor vessel 82a.

After a predetermined reaction time has elapsed, in particular about 10 min or less, the treated aqueous medium is removed from the first reactor vessel 82a and discharged via the line 96a and supplied back to the circuit (line 40) via the line 96.

Preferably, the treated aqueous medium is cooled to a second temperature, for example the first temperature of about 65° C., by way of a heat exchanger 98 integrated in the line 96, so that polycondensation reactions that may still be occurring in the medium are slowed down, preferably substantially suppressed.

As depicted in FIG. 2, the recirculation installation 60 preferably comprises a second reactor vessel 82b. This is filled with aqueous medium to be treated time-offset relative to the first reactor vessel 82a, said aqueous medium being fed via the line 80 and the line 80b preferably into the upper region of the second reactor vessel 82b.

As previously described for line 96, the heat exchanger 98 is also integrated into the line 80 in such a way that the media conducted through the lines 96 and 80, i.e. the treated aqueous medium and the medium to be treated, are conducted counter currently while exchanging heat.

Advantageously, this minimizes the energy requirement of the recirculation installation 60 and also ensures that the treated aqueous medium is cooled to a second temperature after the predetermined reaction time has elapsed.

The volume of the reactor vessels 82a and 82b is selected in each case so that in the aqueous medium to be treated a sufficient chemical binding of a proportion of formaldehyde can be achieved in the predetermined reaction time of, for example, about 10 minutes or less, said proportion preferably corresponding at least approximately to the simultaneous formaldehyde input into the aqueous medium from the raw gas in the wet filter installation 10.

The aqueous medium treated in the reactor vessels 82a, 82b is removed via a respective line 96a and 96b connected in the lower region of the reactor vessels 82a, 82b, as already described, and returned to the circular flow of the aqueous medium and used in the wet filter installation 10, in particular the spray scrubbing apparatus 26.

If a predetermined upper limit value of the content of chemically bound formaldehyde is reached in the aqueous medium, a proportion of this aqueous medium is removed, for example via the line 100 branching off from the line 96, and is optionally subjected to a regeneration process as described in the literature (see in particular the BAT Reference Document for Common Waste Water and Waste Gas Treatment/Management Systems in the Chemical Sector; February 2003; German Federal Environmental Agency).

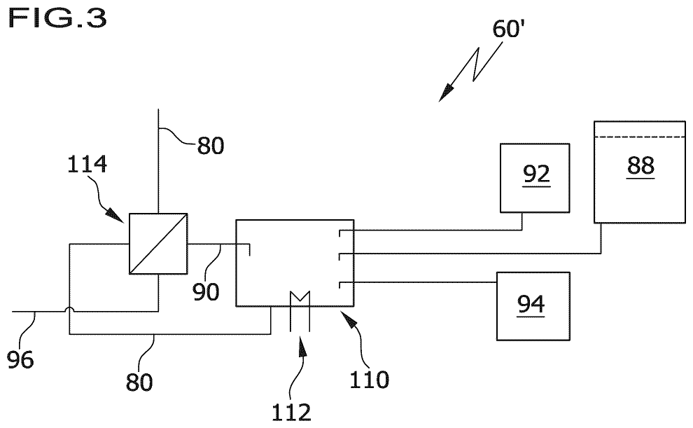

In a simplified embodiment of the recirculation installation 60′, one single reaction zone, in this case one single reactor vessel 110, can also be worked with, as shown in FIG. 3, wherein, unlike in the previously described embodiment of FIG. 2, the aqueous medium to be treated is supplied to the reactor vessel 110 from the line 80 in a lower region, and the treated medium is removed via the line 90 in an upper region of the reactor vessel 110. This arrangement optionally allows continuous processing in the reactor vessel 110.

The reactor vessel 110 optionally has a heating apparatus 112. Furthermore, the reactor vessel 110 is supplied as required with base from the storage tank 88, catalyst from the catalyst tank 92, and optionally co-catalyst from the tank 94 containing co-catalyst.

The throughput rate of the aqueous medium in the single reactor vessel 110 is controlled in continuous operation such that the aqueous medium in the reactor vessel 110 has a dwell time corresponding to the predetermined reaction time. In turn, the inflow and outflow of aqueous medium are conducted in opposite directions through a heat exchanger 114, such that an energy-optimized mode of operation is achieved in this variant, too. The cooled aqueous medium is fed from the heat exchanger 114 into the line 96 and thus fed back to the circular flow of the gas scrubbing installation 10 via the supply lines 40, 42 to the spray scrubbing installations 26, 30, 32.

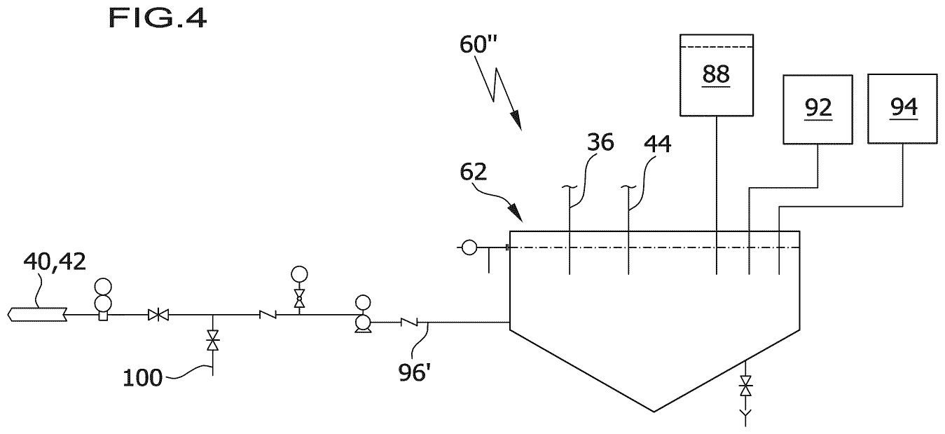

In another simplified embodiment of the recirculation installation 60″, as shown in FIG. 4, the reaction zone is provided by the recirculation tank 62. In its function as a reaction zone, the recirculation tank 62 is supplied as required with base from the storage tank 88, catalyst from the catalyst tank 92, and optionally co-catalyst from the tank 94 containing co-catalyst.

The retreated aqueous medium can then be supplied directly via the line 96′ to the circuit of the gas scrubbing installation 10 via the supply line 40, optionally also via the supply line 42, so that the retreated aqueous medium can be dispensed by the spray scrubbing apparatus 26 and optionally the spray scrubbing apparatuses 30, 32.

This embodiment is of particular interest if the aqueous medium as a whole can be kept at a comparatively high temperature of, for example, about 85° C., so that the heating and cooling of the aqueous medium before and after regeneration respectively can usually be omitted.

### EXAMPLES

In the following examples, the performance of the method in accordance with examples disclosed herein is described in detail. An installation size of a wet filter installation 10 with a raw gas throughput of about 450,000 Nm³/h (Nm³=standard cubic meter) is considered. For example, such an installation is available as a wet electrostatic precipitator from the company Durr Systems AG.

The input concentration of formaldehyde in the raw gas is subject to process-related fluctuations and is assumed in the following examples to be on average 25 to 50 mg/Nm³. A recirculation tank 62 (buffer tank) with a volume of 65 m³ is available for the aqueous medium pumped in the circuit (hereinafter also referred to as process water). The process water is circulated by means of pumps, as has already been described in connection with FIGS. 1 and 2. The amount of process water circulated per hour is approximately 10 times the volume of the recirculation tank 62 (buffer tank).

The separation apparatus for solids (filter apparatus 12) corresponds to the prior art and may be, for example, a rotary sieve with a corresponding mesh size from the company Huber SE in combination with centrifuges from the companies Flottweg or Hiller.

### Example 1

In wet electrostatic precipitators (WESP), the process air loaded with dust and pollutants (raw gas) is cooled by means of an upstream spray scrubbing apparatus 26 (also called spray quench) from, for example, 135° C. to less than 100° C., typically about 60° C. to 75° C. and the raw gas is thereby saturated with water. The formaldehyde contained in the process air is hereby absorbed almost completely in the water. The water volume evaporating during this step is about 3 m³/h and is replaced continuously.

In addition, a further proportion of water (about 1 m³) is drained or discharged from the circuit and replaced by fresh water in order to be able to discharge the reaction products of the formaldehyde and possibly pollutants chemically bound in the aqueous medium. Preferably, this proportion is discharged from the line 96 via the branching line 100, since in accordance with examples disclosed herein the lowest formaldehyde concentration in the system is present here and the heat has already been recovered.

In the quasi-closed system of the wet filter installation 10 and recirculation installation 60, formaldehyde in the form of methanediol accumulates after just a few hours to a concentration of 150 mg/l or more. Process water enriched in this way loses cleaning effect significantly with respect to formaldehyde, and the concentrations in the gas phase (clean gas) rise nearly to the values of the input load before the spray scrubbing apparatus 26 (raw gas).

In order to counteract this accumulation of formaldehyde/methanediol, in accordance with examples disclosed herein, a partial stream of the aqueous medium is reacted in a reaction zone, here in an additional reactor vessel 82a or 82b, each with a capacity of about 5 m³, and formaldehyde is chemically bound, in the present example converted into non-toxic non-volatile sugar compounds. For this purpose, the process water from the recirculation tank 62 is heated from typically 60° C. to 75° C. to a temperature of about 90° C. Under constant stirring, one mole of calcium hydroxide as catalyst and 0.33 mole of fructose as co-catalyst is added per mole of dissolved formaldehyde/methanediol. In parallel, the pH value is set to about 12 by adding sodium hydroxide solution. The catalyst and co-catalyst can ideally be premixed under heating, as fructose significantly increases the solubility of calcium hydroxide and thus deposits can be avoided.

The reaction in the reaction vessel 82a and 82b is terminated after about 5 to 10 minutes in order to avoid a further reaction of the formed sugars in the alkaline with residues of formaldehyde or with one another by crossed aldol reactions to sugar acids. For this purpose, the aqueous medium is discharged from the reactor vessels 82a and 82b via the lines 96a and 96b respectively, and the treated aqueous medium is cooled to a temperature of 70° C. or less as quickly as possible by way of the heat exchanger 98.

A heat recovery by way of the heat exchanger 98 with simultaneous preheating of the next reaction batch is a preferred technical execution. The necessary fresh water can also be used to cool the treated aqueous medium.

To control and calculate the required quantities of catalyst and co-catalyst, the pH value is monitored during the 5 to 10 minute reaction time. As stated above, with the end of the reaction and the associated lack of condensable formaldehyde, the pH value drops dramatically due to the formation of carboxylic acids.

This so-called tipping point serves as a signal for the end of the predetermined reaction time and the subsequent cooling to be performed. By regularly measuring the content of chemically unbound formaldehyde in the aqueous medium in the reactor vessel and in the circuit, for example by means of photometric methods (VDI 3862 Sheet 6:2004-02 Gaseous Emission Measurement; Measurement of Formaldehyde by the Acetylacetone Method, Beuth Verlag, Berlin; Gas chromatography (ASTM D5197-16 Standard Test Method for Determination of Formaldehyde and Other Carbonyl Compounds in Air (Active Sampler Methodology)) or by countertitration of the sodium ion released during sulfite addition, the required amount of catalyst and co-catalyst is permanently adjusted and re-dosed.

The solubility of the calcium ions is improved by chelating effects of the formed and/or added sugars and formosis reaction products. It is therefore rather irrelevant for the overall process whether the entire formaldehyde is completely reacted in a batch, i.e. during one reaction time, since in the case of a repeated reaction procedure of at least once per hour, the content of 150 mg/l mentioned in this example drops permanently to significantly below 1 mg/l. This achieves an outlet concentration of formaldehyde in clean gas of 1 mg per Nm³ or less.

Unlike described in DE 27 21 186 C2 (page 23, line 5 ff.), in accordance with examples disclosed herein, a large portion of the aqueous medium is kept in the system in order to conserve this resource. For this purpose, the method in accordance with examples disclosed herein, unlike described in DE 27 21 186 C2, is not operated close to the boiling point of the water in order to be able to concentrate the products. Also, no polyalcohols (produced by reduction/hydrogenation of the formosis sugars) are used to ensure the adsorption of formaldehyde by acetal formation close to the boiling point of the water.

In the method in accordance with examples disclosed herein described herein, cooler aqueous medium (e.g. process water at about 65° C. to about 70° C.) and a reaction temperature in the range of about 70° C. to about 95° C. are sufficient.

The reaction products of the formaldehyde obtained in the method in accordance with examples disclosed herein can also be degraded in an environmentally friendly manner, as described below, so that the aqueous medium treated in this way can optionally also be returned to the circuit.

A preferred method, in particular to degrade the sugars formed in the method in accordance with examples disclosed herein, is described in the BAT Reference Document for Common Waste Water and Waste Gas Treatment/Management Systems in the Chemical Sector; February 2003; German Federal Environmental Agency.

### Example 2

The technical parameters correspond to those of Example 1. As a recirculation installation, the variant 60′ shown in FIG. 3 is used with only one reactor vessel 110. Only lime milk is used as a catalyst and for setting the pH value. This can be added directly to the recirculation tank 62 until the process water therein has a pH value of 11 or more.

On the one hand, process water set in such an alkaline state causes effective chemisorption and thus a significantly improved separation of the formaldehyde from the gas phase of the raw gas due to deprotonation of the dissolved methanediol and the formation of the resulting salt Ca(OCH₂OH)₂.

This allows the scrubbing performance of the gas scrubbing installation to be increased at the beginning, but a backreaction occurs as soon as formaldehyde and Ca(OH)₂ are in equilibrium with the resulting salt Ca(OCH₂OH)₂.

In addition, the less reactive sucrose is added to the entire process water as a co-catalyst until a concentration of about 0.01 mol/l is reached.

Now, to start an irreversible polycondensation of the formosis reaction, the process water is continuously pumped through reactor vessel 110. The pH value is hereby constantly controlled and adjusted to and maintained at a value of 12 or more by adding lime milk.

To achieve an average dwell time of the process water of about 2 minutes in the reactor vessel 110 and to maintain a reaction temperature of about 65° C. to about 70° C., the pump capacity, reactor vessel size, and heat recovery are dimensioned in such a way that the entire amount of process water from the gas scrubbing installation passes through this reactor vessel 110 at least once an hour. The temperature in the recirculation tank 62 is controlled by means of heat recovery and optional cooling and maintained, for example, in a value range of about 25° C. to about 35° C.

### Example 3

The process conditions are as described in Example 2, however, the polycondensation reaction is accelerated, with an addition of en-diol-capable compounds, for example fructose and glucose, in addition to the sucrose used in Example 2 into the reaction vessel 110.

The addition to the reactor vessel 110 is carried out in an amount of 0.1 mole of the en-diol-capable compounds per 1 mole of chemically unbound formaldehyde. At such a dosage, the reaction temperature can be reduced to about 50° C.

This reaction regime can be advantageously selected, in particular, when larger amounts of process water with a less high pH value are to be discharged.

As a result of the rearrangement and decomposition of formose reaction products that is achieved here and has already been described above, hydroxide-ion equivalents are consumed that are not directly involved in the conversion of the formaldehyde.

Subsequent wastewater treatment takes place under aerobic conditions by means of bacteria to ensure rapid conversion of the dissolved sugar derivatives, in particular into CO₂ and water.

The lime milk used supports flocculation and subsequent separation of particulate components in the process water. The addition of NaOH for setting the pH value can be omitted here. In addition, sodium ions would be more of a hindrance here because of their large solvate shell and single negative charge and would disrupt flocculation.

1. A method comprising: reducing a content of formaldehyde of an aqueous medium conducted in a circular flow, wherein the formaldehyde in the aqueous medium is chemically bound during a predetermined reaction time in a reaction zone in the course of a formosis reaction in such a way that a release of formaldehyde from the aqueous medium into a gas phase at a temperature of 95° C., an ambient pressure of 1 bar, during a test time interval of 10 min is limited to a concentration of formaldehyde in the gas phase of about 1 ppm or less, wherein the aqueous medium for chemically binding the formaldehyde in the course of the formosis reaction in the reaction zone for the predetermined reaction time is held at a reaction temperature of about 50° C. to about 100° C. and the pH value of the aqueous medium is set to an alkaline pH value in the range of about 11 to about 14.

2. Method in accordance with claim 1, wherein the reaction temperature of the aqueous medium during the predetermined reaction time is about 55° C. to about 100° C.

3. Method in accordance with claim 1, wherein the pH value of the aqueous medium is set to a pH value in the range of about 11 to about 13.

4. Method in accordance with claim 1, wherein the alkaline pH value of the aqueous medium is set by the addition of an alkaline compound.

5. Method in accordance with claim 1, wherein the chemical binding of the formaldehyde comprises a polycondensation reaction of the formaldehyde in the presence of a catalyst.

6. Method in accordance with claim 5, wherein the aqueous medium comprises a co-catalyst.

7. Method in accordance with claim 1, wherein the predetermined reaction time is about 10 min or less.

8. Method in accordance with claim 1, wherein the aqueous medium, which is held at a reaction temperature of about 70° C. to about 95° C. during the predetermined reaction time, is removed from the reaction zone after the predetermined reaction time and is cooled from the reaction temperature by about 25° C. or more.

9. Method in accordance with claim 8, wherein the cooling of the aqueous medium from the reaction temperature to the second temperature is performed within about 2 minutes or less.

10. Method in accordance with claim 1, wherein a predetermined volume of aqueous medium with a high content of chemically bound formaldehyde is discharged from the circuit and replaced by fresh aqueous medium.

11. Gas scrubbing installation comprising a scrubbing apparatus for absorbing formaldehyde from a gas phase into an aqueous medium while forming an aqueous, formaldehyde-containing medium, wherein the gas scrubbing installation comprises a circuit flow for the aqueous medium, wherein the gas scrubbing installation additionally has at least one reaction zone in which the method in accordance with claim 1 is performable.

12. Gas scrubbing installation in accordance with claim 11, wherein the circuit has a heating apparatus for heating the aqueous medium from a first temperature to a reaction temperature before entry and/or upon entry into the reaction zone and/or in the reaction zone wherein the aqueous medium with a reduced content of formaldehyde and the aqueous medium with the original formaldehyde content are conducted in the heat exchanger in opposite directions while mutually exchanging heat.

13. Gas scrubbing installation in accordance with claim 12, wherein the gas scrubbing installation has a cooling apparatus for cooling the aqueous medium from the reaction temperature to a second temperature below the reaction temperate after exiting the reaction zone(s).

14. Gas scrubbing installation in accordance with claim 11, wherein the reaction zone(s) is/are formed by one or more reactor vessel(s).

15. Gas scrubbing installation in accordance with claim 11, wherein the gas scrubbing installation has one or more dosing apparatuses for supplying an agent for increasing the pH value of the aqueous medium in the reaction zone(s) or the reaction vessel(s), and for supplying a catalyst for the polycondensation reaction of the formaldehyde.
